(19) United States
(12) Patent Application Publication
(10) Pub. No.: US 2016/0196418 A1
(43) Pub. Date: Jul. 7, 2016

(54) I/O Device and Communication System

(71) Applicant: Georg BERNITZ, Nürnberg (DE)

(72) Inventor: Georg Bernitz, Nürnberg (DE)

(21) Appl. No.: 14/653,402

(22) PCT Filed: Dec. 27, 2013
(86) PCT No.: PCT/EP2013/078058

§ 371 Date: Jun. 18, 2015

(30) Foreign Application Priority Data
Dec. 27, 2012 (DE) 10 2012 113 116.3

(51) Int. Cl. G06F 21/35; G06F 3/06; G06F 13/38; G06F 13/20

(52) U.S. Cl. CPC G06F 21/35; G06F 13/20; G06F 3/0635; G06F 3/0656; G06F 13/385; G06F 3/0673; G06F 3/0622; G06F 2221/2129

(57) ABSTRACT

The invention relates to an I/O device (2) with an energy unit (8) for mobile operations of the I/O device (2), an input device (11), an output device (12), and an interface (16) which is designed as a transceiver unit and by means of which the I/O device (2) can be wirelessly coupled to at least one external data processing unit (3, 4) in order to exchange data. According to the invention, the input device (11) is connected to the interface (16), in particular in a direct manner, via a data export path in order to transmit data to the data processing unit (3, 4), and the output device (12) is connected to the interface, in particular in a direct manner, via a data import path order to receive data from the data processing unit (3, 4) such that data input by the user using the input device (11) can be immediately transmitted to the external data processing unit (3, 4) without being processed by the I/O device (2), and the input data processed into output data by the external data processing unit (3, 4) can be immediately output without being processed by the I/O device (2).

### FIELD OF THE INVENTION

The present invention refers to an I/O device and a communication system with such an I/O device.

### BACKGROUND

The mobile communication devices that are generally known, such as mobile telephones, especially smartphones, must perform increasingly better to satisfy customer expectations. To achieve this, they need ever more powerful computational/control units and storage units. However, it is precisely in the mobile application area where limits are set because the communication device for mobile use must still be lightweight and yet have a handy design. Consequently, mobile telephones can be equipped with more powerful computational/control units and storage units up to a certain point because their weight increases with more power.

### SUMMARY OF THE INVENTION

An object of the present invention is therefore to create an I/O device and communication system for mobile use that is very lightweight for mobile use and very powerful at the same time. Additional objects and advantages of the invention will be set forth in part in the following description, or may be obvious from the description, or may be learned through practice of the invention.

The objects are solved by an I/O device and a communication system having the characteristics described and claimed herein.

According to the invention, the I/O device has an energy unit for the mobile operation of the I/O device, an input device, an output device, and an interface designed as a transceiver. By means of the interface, the transceiver can be wirelessly coupled to at least one external data processing unit, particularly to a stationary or mobile computational unit and/or to a communication network. To transmit data to the data processing unit, the input device is connected via a data export path. Furthermore, the output device is connected, especially directly, to the interface via a data import path for receiving data from the data processing unit. The interface, the data export and/or data import path have been designed in such a way that the user can send the input data entered with the input device immediately (i.e. without being processed by an I/O device) to the external data processing unit. Moreover, the input data processed to output data by the external data processing unit can be immediately output, especially displayed, i.e. without processing by the I/O device.

Preferably, the I/O device consists of one energy unit for the mobile operation of the I/O device, one input device, one output device, and one interface. The interface has been designed so it is capable of coupling the input device and the output device, especially separately from one another, wirelessly to at least one stationary or mobile computational unit and/or a communication network, particularly Intranet and/or Internet. Thus, there is no direct connection between the input device and output device. This allows the data sent by the computational unit and/or communication network to the I/O device to be shown in the output device, so the user's commands entered through the input device can be sent immediately to the computational unit and/or communication network without processing by the I/O device. Thus, the I/O device is uncoupled from the computational unit and/or communication network. The I/O device has no computational unit and storage unit and thus its weight is reduced significantly. Instead, these heavy components are placed outside in the communication network and/or in the computational unit. The computational and storage power of the computational unit and/or of the communication network can thus be increased as desired without adding weight to the I/O device, thus limiting mobile use. The I/O device serves exclusively to display and enter information. The actual processing and storage of this information is uncoupled from the I/O device, whereby by means of a wireless connection—particularly radio, wireless LAN, Bluetooth or the like—it is possible to access the computational, control and storage capacity directly.

It is advantageous if the input device and the output device are executed as one single unit, especially as a touch-sensitive and/or flexible surface or foil where image data can be visualized. This allows the user friendliness of the I/O device to be enhanced, so that the user can intuitively capture and enter data.

It is also advantageous if the output device has fast buffer storage for the short-term buffering of the data, especially image data, sent by the computational unit so that fluid information display can be ensured even with bad network reception.

It is also advantageous if the energy unit has energy storage, especially a rechargeable battery and/or energy source, particularly a solar cell, to ensure longer mobile operation of the I/O device.

It is likewise advantageous if the energy input has a microphone, at least a key, touchpad and/or touch screen for the easy and intuitive entering and sending of information, and/or the output device comprises a loudspeaker and/or display.

It is advantageous if the I/O device is designed to be capable of communicating automatically with the computational unit and/or communication network as soon as it is turned on to ensure direct access to the computational and/or storage capacity of the computational unit and/or communication network.

Additionally, it is extremely advantageous if the I/O device has an authentication element that stores authentication information that is preferably sent to the computational unit and/or communication network when the I/O device is turned on. This prevents unauthorized users from accessing the computational capacity and/or data stored in the storage unit.

According to the invention, the communication system has a stationary or mobile computational unit and/or communication network, especially Intranet and/or Internet. The computational unit and/or communication network have a storage unit for long-term data storage and a computational/control unit for information processing. The computational unit can be part of the communication network, in which case the latter can have many computational units. Furthermore, the communication system comprises a mobile input/output device, designed according to the previous description, in which case the features mentioned above can be present individually or combined in any way. The I/O device is connected to the computational unit and/or communication network by means of a wireless connection. The I/O device is thus uncoupled from the computational unit and/or communication network and therefore has no computational/control unit and storage unit, thereby reducing its weight considerably. Instead, these heavy components are placed outside in the computational unit and/or communication network. In this way, it is possible to increase the computational and storage power of the computational unit and/or communication network as desired without increasing the weight of the I/O device. Therefore, the I/O serves exclusively to display and enter information. The actual processing and storage of this information is uncoupled from the mobile I/O device, so by means of the wireless connection, especially via radio, wireless LAN, Bluetooth or the like, it is possible to access the computational, control and storage capacity quickly and directly.

It is advantageous if the computational unit and/or communication network is/are designed to be capable of processing the commands sent by the input device through the interface with their computational/control unit and store the result in their storage unit and/or are capable of sending it back to the output device via the interface. Thus, the I/O device does not need a computational/control unit and/or storage unit arranged inside it, so the I/O device can be designed in a very lightweight way but at the same time can use the computational and/or storage capacity of the computational unit and/or communication network.

It is advantageous if the computational unit and/or communication network are designed in such a way that when the I/O device is turned on, an authentication check is carried out and/or, preferably when access is authorized, the I/O device is capable of communicating with the computational unit and/or communication network, preferably automatically. This can ensure that no unauthorized users can access the computational capacity and/or data stored in the storage unit.

It is advantageous if the authentication information is stored in the storage unit and the computational/control unit can compare it with the authentication information entered by the user into the input device and transmitted to the computational unit and/or communication network, preferably automatically, in an authentication element of the I/O device.

### BRIEF DESCRIPTION OF THE DRAWINGS

Further advantages of the invention are described in the following embodiments, which show:

FIG. 1 a schematic drawing of a communication system with a mobile I/O device connected wirelessly to a computational unit of a communication network.

### DETAILED DESCRIPTION

Reference will now be made to embodiments of the invention, one or more examples of which are shown in the drawings. Each embodiment is provided by way of explanation of the invention, and not as a limitation of the invention. For example features illustrated or described as part of one embodiment can be combined with another embodiment to yield still another embodiment. It is intended that the present invention include these and other modifications and variations to the embodiments described herein.

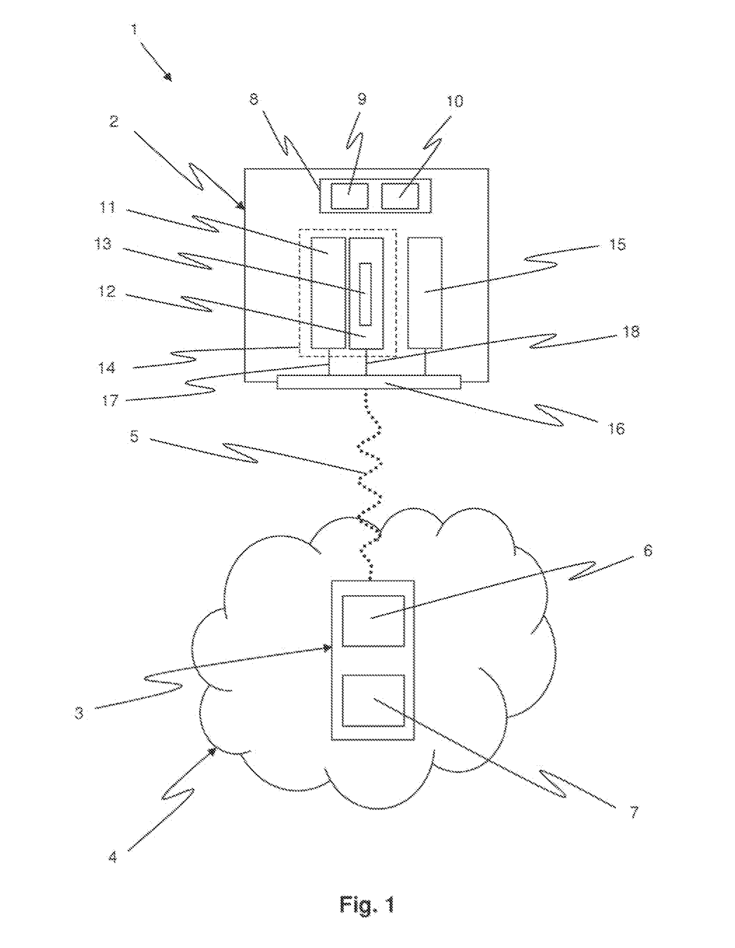

FIG. 1 shows a schematic drawing of a communication system 1, which has an I/O device 2 and a computational unit 3 arranged in a communication network 4. In this embodiment, the computational unit 3 has a static design; it comprises a storage unit 6 for long-term data storage and a computational/storage unit 7 for information processing. In the embodiment shown here, the communication network 4 represents the Internet to which the I/O device is 2 linked via a wireless connection 5.

The I/O device 2 has an energy unit 8 for the mobile operation of the I/O device. The energy unit 8 comprises an energy storage unit 9, especially a rechargeable battery, which can be recharged through an interface (not shown). Furthermore, the energy unit 8 comprises an energy source 10 executed as solar cell, for example, so its energy can be used to supply the energy storage unit 9.

The I/O device 2 has an input device 11 and an output device 12. By means of the input device 11, the user of the I/O device 2 can enter commands. The output device 12 can display information, especially pictorial information. Moreover, the output device 12 encompasses fast buffer storage 13 used for stabilizing images, The input device 11 and the output device 12 are executed as a unit 14, which is preferably designed as a touch-sensitive display.

The I/O device 2 also comprises an authentication element 15 to store authentication information. However, the authentication element 15 does not have to be necessarily provided, so in an alternative embodiment not shown here, it is just as conceivable for the authentication information, especially a password, to be entered into the I/O device 2 directly through the input device 11, especially when the computational unit 3 requests it.

The I/O 2 device comprises additionally an interface 16. The input device 11 is connected to the interface 16 via a data export path 17. Moreover, the output device 12 is connected to the interface 16 via a data import path 18. The data export path 17 and/or the data import path 18 are executed in a unidirectional way, i.e. data transmission can take place in only one direction. Furthermore, the two paths 17, 18 are uncoupled from one another. Thus, no data exchange can take place between the input device 11 and the output device 12 within the I/O device 2. The interface 16 is executed in such a way that it connects the input device 11 and the output device 12 to the external data processing unit, especially the computational unit 3, via the wireless connection 5. The input device 11 and the output device 12 are in each case connected separately to the interface 16 so no information can be exchanged between the input device 11 and the output device 12 and/or be processed by either one of them. Instead, the I/O device can merely receive user commands via the input device 11 and forward them to the computational unit 3 or the communication network 4 or display information sent by the computational unit 3 by means of the output device 12.

Thus, the heavy elements of a computer system, namely the storage unit 6 and the computational/storage unit 7, are advantageously uncoupled from the input device 11 and the output device 12, so that an I/O device 2 can be executed with little weight. Furthermore, no boundaries are set to the system's storage and computational capacity because the computational unit 3 can be placed in any location, preferably stationary, and thus can have any size and weight without limiting the mobility of the I/O device.

The data sent from the computational unit 3 and/or the communication network to the I/O device 2 are reproduced only in the output device 12. The commands entered by the user via the input device 11 are sent to the computational unit 3 or the communication network 4 via the wireless connection 5 immediately without being processed by the I/O device 2.

The computational unit 3 is designed to allow it to process the commands sent from the input device 11 via the interface 16 with its computational/control unit 7. In addition, the computational unit 3 or the communication network 4 can store this command information or also store the calculated results in the storage unit 6 and/or sent it back via the wireless connection 5 and the interface 16 to the output device 12 of the I/O device 2, where this information can be transmitted back to the user visually, acoustically and/or haptically.

Basically, the communication network 4 can have several computational units 3, in which case at least one of these computational units 3 always is always turned on. As soon as the user turns on the I/O device 2, it connects automatically via the interface 16 by means of the wireless connection 5 to the communication network 4 or the turned-on computational unit 3. To prevent access of unauthorized persons to the computational unit 3, the computational unit 3 and/or the communication network 4 is/are executed in such a way that an authentication check is carried out when the I/O device 2 is turned on. To do this, the users authentication information is stored in the computational unit 3, particularly in the storage unit 6. Alternately, this authentication information can also be stored, however, in a secure section of the computational unit 3, particularly of the storage unit 6. As soon as the I/O device 2 is turned on, the computational unit 3 sends an authorization request to the I/O device 2, whereby the prompt on the output device 12 to enter authentication information, especially a password, is displayed. Now the user can enter the required authentication information with the input device 11 and this information is sent via the interface 16, unprocessed, to the computational unit 3 via the wireless connection 5. Afterwards, the computational unit 3 carries out an authentication check and as soon as authorization is verified, access is allowed to the I/O device 2 on the computational unit 3.

Alternately, however, the I/O device 2 can also have an authentication element 15 (as shown in FIG. 1) on which the individualized authentication information is stored. As soon as the I/O device 2 is turned on, the computational unit 3 and/or the communication network 4 automatically initiate the wireless connection 5 by means of the interface 16 of the I/O device 2. In this case, the computational unit 3 automatically reads the authentication information stored in the I/O device 2 from the authentication element 15. The computational unit 3 compares this authentication information sent and/or read by the I/O device 2 with the authentication information stored in the storage unit 6. When the computational/control unit 7 reaches an authorization confirmation, it allows the I/O device 2 full access to the computational unit 3. Thus, the user can access all the data stored in the storage unit 6 and make use of the computational capacity of the computational/control unit 7. Advantageously, the user can therefore use the very high storage and computational capacity of the stationary computational unit 3 while having a very lightweight, mobile communication device because the I/O device 2 has been largely reduced to the input device 11, output device 12 and interface 16.

The present invention is not limited to the embodiment shown and described. Modifications as part of the patent claims are just as possible as a combination of the characteristics, even if they are shown and described in different embodiments.

### LIST OF REFERENCE SIGNS

1 Communication system
2 I/O device
3 Computational unit
4 Communication network
5 Wireless connection
6 Storage unit
7 Computational/control unit
8 Energy unit
9 Energy storage unit
10 Energy source
11 Input device
12 Output device
13 Buffer storage
14 Unit
15 Authentication element
16 Interface
17 Data export path
18 Data import path

1-12. (canceled)

13. An Input/Output (I/O) device, comprising:
an energy unit for mobile operation of the I/O device;
an input device;
an output device;
an interface configured as a transceiver, by means of which the I/O device is coupled wirelessly to an external data processing unit for exchanging data;
the input device connected directly to the interface for transmitting data to the external data processing unit via a data export path;
the output device connected directly to the interface for receiving data from the external data processing unit via a data import path; and
wherein data entered by a user via the input device is sent directly, without processing by the I/O device, to the external data processing unit, and the input data processed by the external data processing unit is entered as output data to the output device without needing processing by the I/O device.

14. The I/O device according to claim 13, wherein the data export path and the data import path are uncoupled from one another.

15. The I/O device according to claim 13, wherein the input device and the output device are executed as a single unit that includes one of a touch-sensitive surface, a flexible surface, or a foil that can visualize pictorial data to the user.

16. The I/O device according to claim 15, wherein the output device comprises a buffer storage for short-term buffering of the pictorial data sent by the external data processing unit.

17. The I/O device according to claim 13, wherein the energy unit comprises one or both of an energy storage unit and an energy source.

18. The I/O device according to claim 13, wherein the input device comprises any combination of a microphone, a touchpad, and a touch screen, and the output device comprises any combination of a loudspeaker and a display.

19. The I/O device according to claim 13, wherein the I/O device is configured, upon being turned on, to communicate automatically with the external data processing unit via a communication network.

20. The I/O device according to claim 19, further comprising an authentication element on which authentication information is stored and sent automatically to the external data processing unit upon the I/O device being turned on.

21. A communication system, comprising:
the I/O device according to claim 13, wherein the I/O device is a mobile device;
a computational unit in wireless communication with the I/O device via a communications network, the computational unit further comprising:
a storage unit for long-term data storage; and
a control unit for information processing of data from the I/O device and transmission of the processed information to the I/O device.

22. The communication system according to claim 21, wherein the I/O device interface is in communication with the computational unit via the communications network, the computational unit processing commands sent by the input device via the interface with the control unit and storing the processing results the storage unit and sending the processing results back to the output device via the communications network and the interface.

23. The communication system according to claim 21, wherein the computational unit is configured such that, when the I/O device is turned on, the computation unit performs an authentication check and, when access is authorized, automatically connects to connect the I/O device.

24. The communication system according to claim 23, wherein the authentication information is stored in the storage unit, the control unit configured to compare the stored authentication information with authentication information entered by a user into the input device and transmitted to the computational unit or stored in an authentication element of the I/O device.
